(19) United States
(12) Patent Application Publication
(10) Pub. No.: US 2011/0132045 A1
(43) Pub. Date: Jun. 9, 2011

(54) TRAILER SECURITY

(75) Inventor: Mitch Hughes, Mustang, OK (US)

(73) Assignee: S/C Motorsports, Mustang, OK (US)

(21) Appl. No.: 12/856,453

(22) Filed: Aug. 13, 2010

Related U.S. Application Data
(60) Provisional application No. 61/233,733, filed on Aug. 13, 2009.

(51) Int. Cl. E05B 65/12

(52) U.S. Cl. 70/57

(57) ABSTRACT

A trailer security apparatus is mounted to the frame of a trailer to prevent an unauthorized usage of the trailer. The trailer security apparatus has a switch that is selectively moveable between an unlocked position and a locked position. The trailer security apparatus also has a lock device responsive to the switch to clearingly disengage from wheels on the trailer to permit rolling the trailer in the unlocked position of the switch, and to interferingly engage one or more of the wheels on the trailer to prevent rolling the trailer in the locked position of the switch.

### RELATE BACK

This application claims the benefit of the filing date of the earlier filed application 61/233,733.

### FIELD

The present embodiments relate generally to devices and associated methods for securing a trailer from unauthorized usage and theft.

### SUMMARY

In some embodiments a trailer security apparatus is mounted to the frame of a trailer to prevent an unauthorized usage of the trailer. The trailer security apparatus has a switch that is selectively moveable between an unlocked position and a locked position. The trailer security apparatus also has a lock device responsive to the switch to clearingly disengage from wheels on the trailer to permit rolling the trailer in the unlocked position of the switch, and to interferingly engage one or more of the wheels on the trailer to prevent rolling the trailer in the locked position of the switch.

### BACKGROUND

Trailers by design are self contained units that are easily towed behind a vehicle. That makes them particularly susceptible to unauthorized usage and theft. It only takes a few minutes for a thief to back her vehicle to a trailer and connect to it. From all outward appearances, such a thief stealing a trailer can easily be mistaken for the rightful owner routinely hooking up to the trailer for a legitimate use. That makes it likely the thief can steal a trailer in broad daylight and go unnoticed by witnesses.

Previously attempted solutions have employed a multitude of various different mechanical and electromechanical devices in attempts to protect trailers from such unauthorized usage or theft. Those devices are typically rendered ineffective by fast and rudimentary measures carried out with commonplace tools like crowbars and cable cutters. A good number of previously attempted solutions are particularly directed at various ways of making the trailer tongue inaccessible for matingly engaging the vehicle's hitch. Those attempts can even more quickly be completely bypassed by the thief simply temporarily hooking the vehicle up to the trailer by some means other than via the trailer tongue. Once breached or bypassed, the previously attempted solutions do nothing to prevent the thief's quick getaway and disappearance with the stolen trailer.

Embodiments of the present invention provide solutions to these and other problems, and offer other advantages over the prior art, by making a trailer immovable upon its wheels unless it is unlocked and thereby authorized for usage.

### DESCRIPTION OF THE DRAWINGS

FIG. 1 is a diagrammatic depiction of a trailer that is useful for using an apparatus and practicing a method of the embodiments of the present invention.

FIG. 2 is functional block depiction of a trailer security apparatus that is constructed in accordance with the present embodiments.

FIG. 3 is a schematic representation of the path 29 in FIG. 2.

FIG. 4 is a schematic representation of a charging circuit for the apparatus of FIG. 2.

FIG. 5 is an isometric depiction of a trailer lock device that is constructed in accordance with embodiments of the present invention.

FIG. 6 depicts an opposing side of the lock device in comparison to FIG. 5.

FIG. 7 depicts the same side of the lock device in comparison to FIG. 5.

FIG. 8 is similar to FIG. 6 but depicts an exploded isometric depiction.

FIG. 9 is a partial cross sectional depiction of an extensible bolt constructed in accordance with embodiments of the present invention.

FIG. 10 is an isometric depiction of a trailer lock device that is constructed in accordance with other embodiments of the present invention.

FIG. 11 is a cutaway view of the lock device of FIG. 10.

FIG. 12 is an enlarged detail view of a portion of the lock device of FIG. 11.

### DETAILED DESCRIPTION

Generally, the embodiments of the present invention contemplate devices and associated methods that are used to secure a trailer. The devices are switchable between an unlocked mode, whereby the rolling movement of the trailer upon its own self-contained wheels is unencumbered, and a locked mode, whereby the rolling movement of the trailer upon its wheels is prevented.

The following description focuses on illustratively employing the present embodiments on a breakaway type of trailer, although the skilled artisan will appreciate that the contemplated embodiments are not so limited. That is, the skilled artisan will readily appreciate that the contemplated embodiments can be employed on any type of trailer from those fully equipped with electric brakes and on-board power to those with neither but which can be added to the trailer for purposes of the embodiments of the present invention.

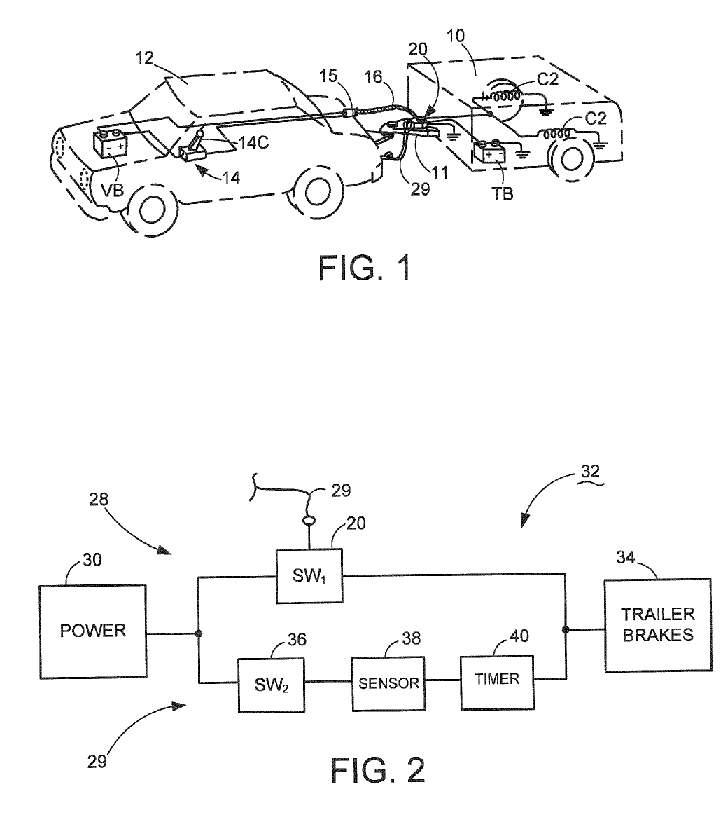

FIG. 1 depicts a related art type of trailer commonly referred to as a “breakaway” trailer 10 which illustrates a type of device that is amenable for using an apparatus and practicing an associated method in accordance with the embodiments of the present invention. Although a utility type trailer is illustratively depicted, the present embodiments are not so limited. Rather, breakaway trailers are widely used in a diverse variety of configurations to make them suitable for hauling various goods and livestock and the like, such as but not limited to fifth wheel trailers, recreational vehicle trailers, car haulers, equipment and construction trailers, and the like.

Generally, the breakaway trailer 10 is provided with some type of electrical communication linkage that is readily disconnectable if the trailer 10 becomes separated from the vehicle 12 towing it. In the illustrative embodiments of FIG. 1 a breakaway switch unit 20 has an electrical switch in a circuit that supplies power from an onboard battery TB to the trailer brakes C₂. A pin is inserted into the switch unit 20 to bias a normally-closed electrical switch to an open position, thereby deenergizing the trailer brakes C₂ with respect to the onboard battery TB. The pin is connected to a lanyard 29 which tethers the pin to the vehicle. If the trailer 10 becomes separated from the vehicle 12, the pin is pulled away from the switch unit 20 so that it no longer biases the normally closed switch to the open position. The switch unit 20 thus in this position supplies power to the trailer brakes C2 to decelerate the trailer so that its momentum is depleted quickly and predictably.

FIG. 2 is a functional block depiction of a trailer constructed in accordance with the present embodiments. Ultimately, the present embodiments are directed to defining the conditions whereby onboard power 30 (such as from battery TB) is connected via intermediate circuitry 32 to energize the trailer brakes 34. The power 30 can be a battery like that discussed above but the claimed embodiments are not so limited, in that alternative equivalent embodiments can employ other power storage devices such as but not limited to capacitive devices and the like. Furthermore, the power storage devices can be intermittently or continuously charged by other devices not shown that transfer otherwise wasted energy, such as the sun's radiant energy or the dynamic energy of the rotating trailer wheels. Alternatively, as discussed below, the power storage devices can be intermittently or continuously charged by an electrical circuit that supplies power from the battery VB in the vehicle 12 while the trailer is connected via the switch unit 20.

FIG. 2 diagrammatically depicts the power 30 being connectable to the trailer brakes 34 via one path 28 that includes the switch unit 20 discussed above. As discussed, when the tethered pin is removed from the switch unit 20 by separation of the trailer 10 from the vehicle 12, an electrical communication path is established from the onboard battery TB to energize the trailer brakes 34.

FIG. 2 also diagrammatically depicts a parallel path 29 that includes a switch 36, sensor 38, and timer 40. Unlike the other path 28, this path 29 is used to selectively employ a security feature for the trailer 10 to prevent its unauthorized usage or theft. The switch 36 generally functions to lock out this security feature when it is not needed, such as when an authorized user is towing the trailer 10. The switch 36 can be a mechanical switching device, such as a tubular type key lock, or in alternative equivalent embodiments the switch 36 can be provided as an electronic access system such as that would require the user to enter a predefined access code to arm or disarm the security feature.

With the switch 36 turned on (or armed), power 30 is provided to a sensor 38 that detects movement of the trailer 10. The movement can be indicative of the fact that the trailer is likely being towed. The sensor 38 can be a mechanical device such as a mercury switch and the like, or alternatively it can be an electronic device such as a piezoelectric vibration sensor or a proximity detector and the like. When the sensor 38 indicates a movement incident has occurred, the sensor 38 responsively triggers the timer 40 which, in turn, immediately energizes the trailer brakes 34 to immobilize the trailer 10. The timer 40 has a predefined dwell interval that it begins counting down if and when the sensor 38 indicates that the movement has ceased. The dwell interval is intended to prevent immobilizing the trailer 10 indefinitely after a false alarm such as might be indicated by incidental movement from someone bumping into the trailer, wind gusts, livestock movement, and the like. The timer 40 can be a solid state electronic device that is easily adjusted to set the dwell time appropriately for the usage conditions.

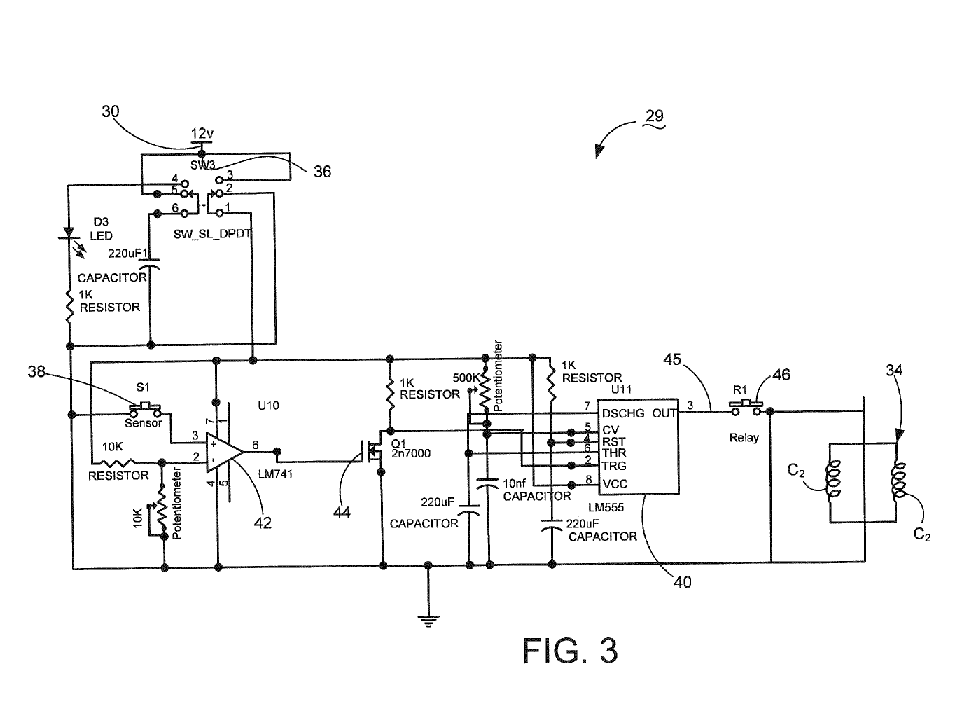

FIG. 3 is an electronic schematic depiction of the path 29 constructed in accordance with illustrative embodiments of the present invention. The power 30 is supplied to the switch 36 which in these illustrative embodiments is a keyed double-pole double-throw switch, although the present embodiments are not so limited. Turning the switch to the “on” position communicates the power 30 to one side of an operational amplifier 42. The other side of the operational amplifier 42 receives a positive output signal from the motion sensor 38 in response to an indication of trailer movement.

The operational amplifier 42 responds to receipt of the positive output signal from the motion sensor 38 to communicate power 30 to a MOSFET 44 which, in turn, energizes the timer 40. The timer 40 in turn sends an out signal 45 that energizes relay 46 to connect power 30 to the coils C2 in the trailer brakes 34. As discussed, the timer 40 also begins to count down the dwell interval if and when the sensor 38 indicates that the movement has ceased, and de-energizes the coils C2 if the dwell interval elapses.

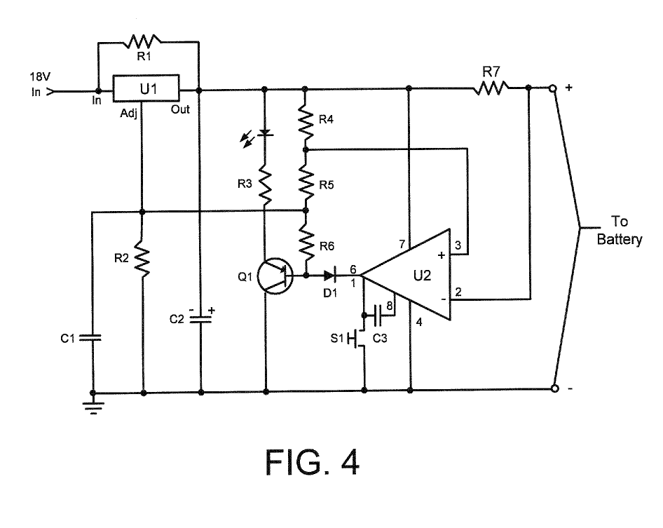

FIG. 4 is an electronic schematic depiction of an auxiliary charging circuit that can be included in the path 29 to electrically charge the onboard battery TB. In these illustrative embodiments, the charging circuit delivers a predetermined full current until such time that the current draw by the battery falls below a predetermined threshold level. At that time, a reduced voltage is applied to finish charging the battery and protect it from being over charged. A light emitting diode is energized to indicate when the battery TB is fully charged. The input voltage for charging can be provided by the input power 30 from the switch 36. Alternatively, the input voltage for charging can be connected to an onboard circuit of the trailer 10, such as in the circuit to the brake lights of the trailer 10. The latter simplifies installing the circuitry of the present embodiments because generally the wires to the brake lights are readily accessible at various locations where it would be convenient to install the control module encasing the additional circuitry of the present embodiments and splice into the brake light wiring.

Other security features can be energized by the sequence of events described above, as desired by the user. For instance, an audible alarm could also be energized by the sensor 38 to sound for a predetermined interval to punctuate the indication that unauthorized usage or theft is occurring. Likewise, a communications device could be energized to send an electronic communication packet to the user's desired location, such as a telephone or email address, to remotely report the unauthorized usage or theft event.

All the foregoing describes the modification of an existing breakaway trailer to equip it with a security system constructed in accordance with embodiments of the present invention. The skilled artisan readily recognizes that trailers that are not the breakaway type can likewise be equipped with the present security system by additionally adding the source of power 30, such as but not limited to a battery or other capacitive device and the like.

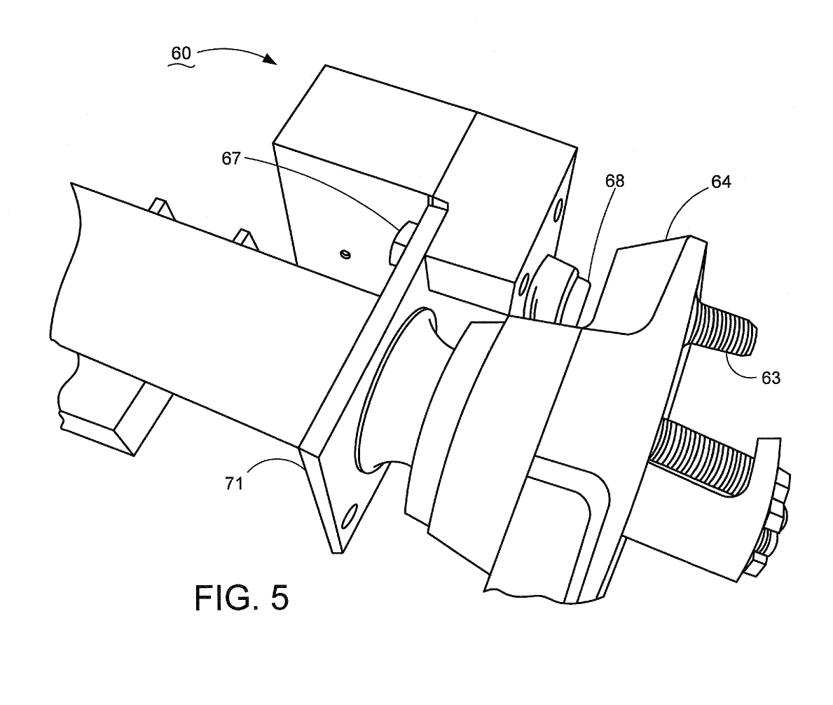

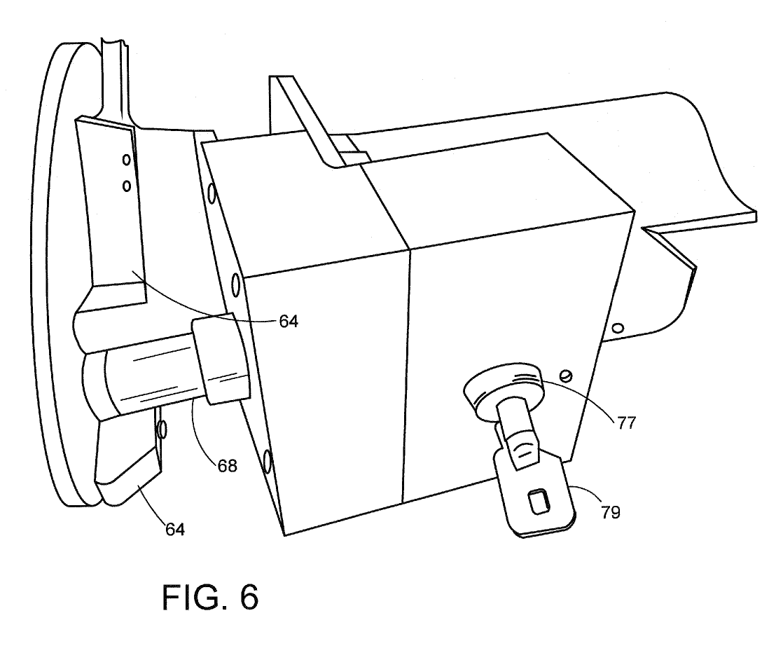

The embodiments described above generally provide a security system that prevents the rolling motion of a trailer that is likely being used without permission or is being stolen. A relatively less complex alternative solution is depicted in the following illustrative embodiments. FIG. 5 depicts a portion of the axle assembly 60 from a trailer that is well suited for using the alternative embodiments described below. The axle assembly 60 includes a bearing mounted hub 62 to which the wheel (not shown) is attached via a lug 63 pattern. The hub 62 has a number of protuberant strengthening features 64 extending from the rear face of the hub 62, opposing the lugs 63. Generally, a locking mechanism constructed in accordance with the present embodiments is attached to the axle assembly 60. The locking mechanism has an extensible bolt 68 that when fully extended is placed in the path of the rotating protuberant features 64 to prevent rotation of the wheels. Here the extensible member 68 is only partially extended such that it does not yet interfere with rotation of the hub 62.

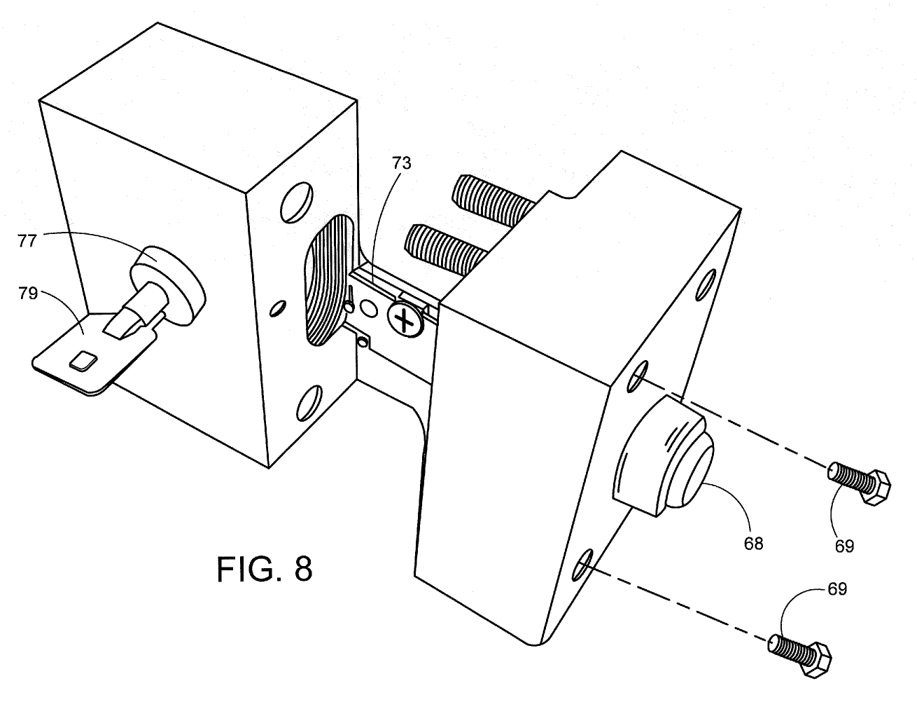

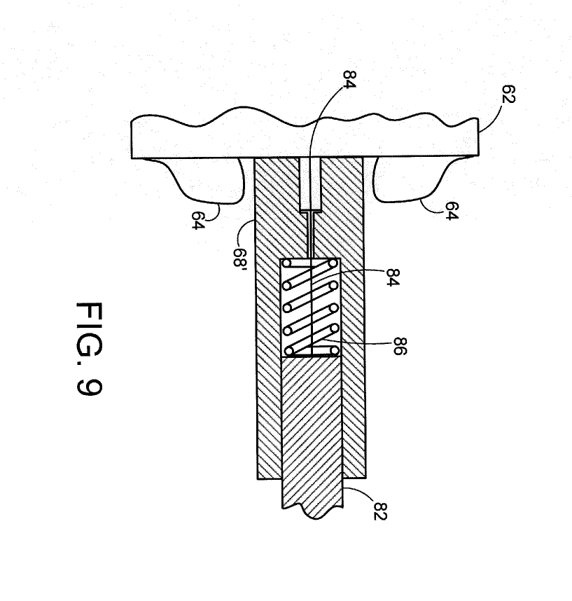

It will be noted that in these illustrative embodiments threaded fasteners 67 are used to attach the locking mechanism to the axle flange 71. Other threaded fasteners 69 (FIG. 8) are used to assemble together cooperative portions of a housing containing a locking member 73 that selectively positions the extensible bolt 68. In these illustrative embodiments a key operated locking member 73 is depicted although the claimed invention is not so limited. In alternative embodiments the bolts 67, 69 could be made to threadingly advance in the opposite direction, away from the hub 62. That would thereby require removing the hub 62 in order to remove the bolts 67, 69, making it more difficult to remove the locking mechanism from the trailer and hence making the trailer more secure.

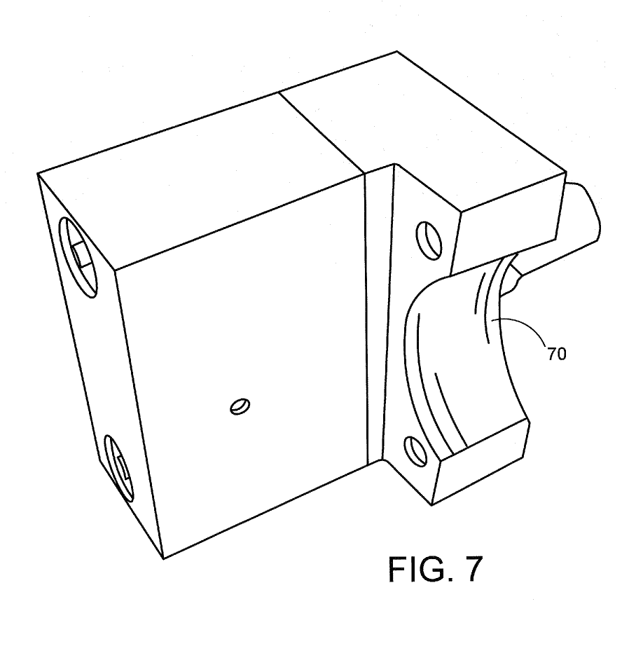

FIG. 6 depicts the opposing side of the locking mechanism, illustrating the use of a key operated tubular lock 77 having a removable key 79. In alternative equivalent embodiments other types of locks can be used, such as but not limited to an electronic keyless lock like a radio frequency emitting device and the like. In these illustrative embodiments, rotating the key selectively extends and retracts the extensible bolt 68. Here the key 79 has been rotated further than in FIG. 5 so as to extend the extensible bolt 68 enough that its distal end now interferes with the rotation of the protuberant features 64 on the hub 62, thereby impeding rolling motion of the trailer. FIG. 7 depicts the same side of the locking mechanism as FIG. 5, but is removed from the axle assembly 60 to show an arcuate relief 70 is provided to clearingly disengage the fixed axle portion of the axle assembly 60.

FIG. 8 is a partially exploded view of the locking mechanism, the housing being formed by a pair of cooperative portions. In alternative embodiments the locking mechanism can have a unitarily constructed body. The keyed lock 77 operates a cam that engages the action of a lock assembly 73 that, in turn, selectively extends the extensible bolt 68 between the retracted and extended positions.

It will be noted that in some rotational positions of the hub 62 the bolt 68 cannot be fully extended without abuttingly engaging the distal end of one of the protuberant features 64. In some embodiments that will be evident to the user because the key can only be removed at the fully retracted and fully extended positions of the bolt 68. In that instance, the trailer would need to be rolled slightly to align a gap between adjacent protuberant features 64 with the path of the extensible bolt 68 to permit fully extending the extensible bolt 68. Alternatively, FIG. 9 depicts a spring loaded bolt 68′ that is moved by another bolt 82 that is controlled by the lock assembly 73 as described above. The bolts 68′, 82 are connected together by a rigid rod 84, so that moving the bolt 82 in the retract direction directly pulls the bolt 68′ likewise in the retract direction. However, a compression member (such as a spring) 86 is compressingly disposed between the bolts 68′, 82. This permits the bolt 82 to move in the extend direction while the bolt 68′ remains stationary, such as when it is abuttingly engaged against the distal end of the protuberant feature 64. In this condition the distal end of the connecting rod 84 is slidingly moveable along a passage in the bolt 68′. This permits activating the locking mechanism to fully extend the bolt 82 without likewise fully extending the bolt 68′. In that condition, the compression member 86 will subsequently exert a force to extend the bolt 68′ when it is possible to do so, such as when a slight rolling movement of the trailer aligns the gap between adjacent protuberant features 64 with the path of the extensible bolt 68′.

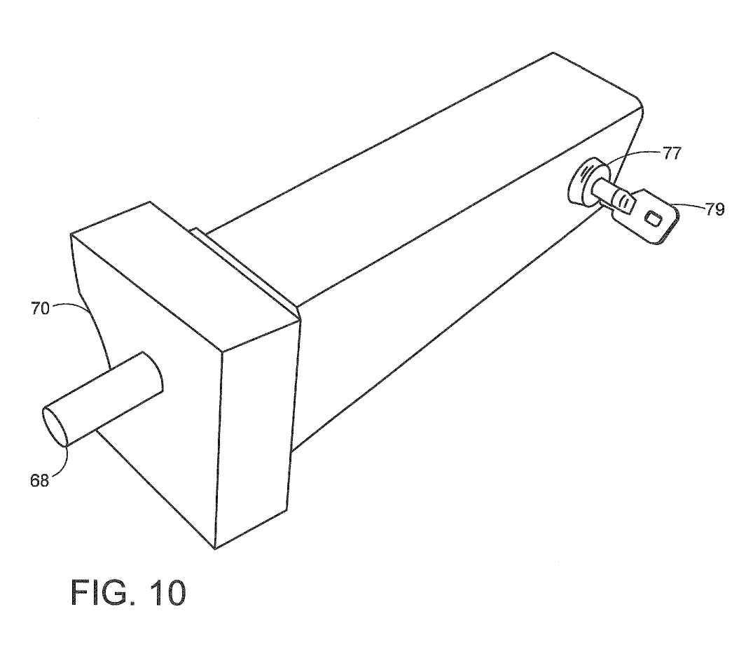

FIGS. 10-13 depict an alternative mechanical construction to that previously depicted in FIGS. 5-9 and the descriptions thereof. FIG. 10 is an isometric depiction of the lock having a similar mounting block with arcuate relief 70 that mounts to the trailer axle flange 71 (see FIG. 5). A two-position cam lock is preferably used so that the key 79 can be removed at both the locked and unlocked key positions, as described below.

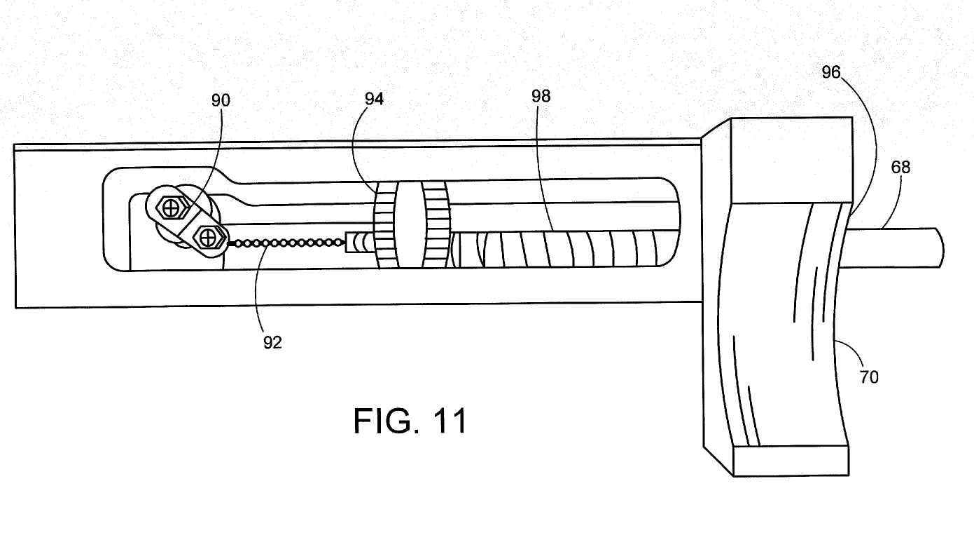

FIG. 11 is a cutaway view depicting the manner in which the cam lock rotates a cam 90 to which a linkage 92 is attached. Note that in these depicted embodiments the linkage 92 is a flexible chain member, but in equivalent alternative embodiments the linkage can be otherwise constructed such as but not limited to using a flexible cable or a rigid linkage member. The other end of the linkage 92 is connected to a proximal end of the extensible bolt 68. The extensible bolt 68 is slidingly supported by a first bushing 94, such as a block of lubricious material like a polymer, and a second bushing 96 concentrically inserted in the mounting plate. The extensible bolt 68 supports a shoulder, such as a retaining clip attached to the bolt 68, and a spring 98 is compressingly engaged between the first bushing 94 and the shoulder to bias the bolt 68 to the extended position depicted in FIG. 11, the extended position thus presenting the distal end of the extensible bolt 68 in an interference relationship with the axle assembly hub 62 (see FIG. 6) to prevent the trailer from being towed. Thus, the cam lock is depicted as being in the locked position in FIG. 11 and the key 79 is removable in the locked position as well.

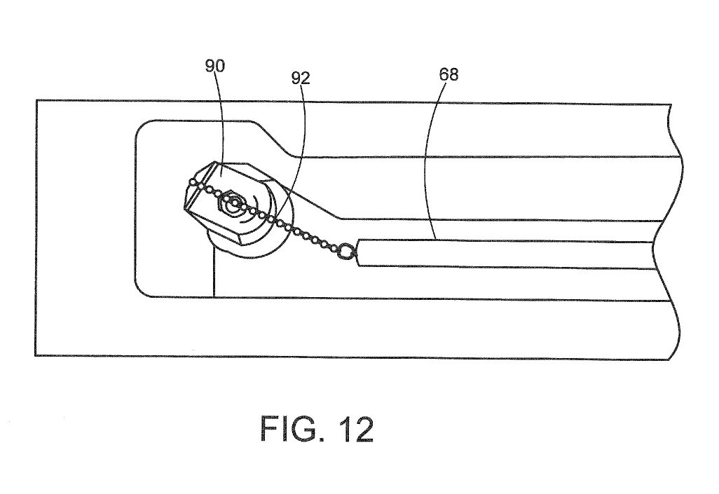

FIG. 12 depicts an enlarged detail of the cam lock having been turned with the key 79 to rotate the cam 90 in a clockwise direction as depicted here to impart a tensile force to the linkage 92 which retracts the extensible bolt 68 to an unlocked position. Thus, the cam lock is depicted as being in the unlocked position in FIG. 12, and the key is removable in the unlocked position.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, features of the illustrated embodiments can be interchanged and the particular elements may vary depending on the particular application while maintaining substantially the same functionality without departing from the scope and spirit of the present invention. In addition, although preferred embodiments described herein are illustrated with respect to a system it will be appreciated by those skilled in the art that the teachings of the present invention can be applied to other systems without departing from the scope and spirit of the present invention.

What is claimed:

1. A trailer security apparatus mounted to the frame of a trailer to prevent an unauthorized usage of the trailer, the trailer security apparatus comprising:
a switch that is selectively moveable between an unlocked position and a locked position; and
a lock device responsive to the switch to clearingly disengage from wheels on the trailer to permit rolling the trailer in the unlocked position of the switch, and to interferingly engage one or more of the wheels on the trailer to prevent rolling the trailer in the locked position of the switch.
